(19) United States
(12) Patent Application Publication
(10) Pub. No.: US 2023/0418663 A1
(43) Pub. Date: Dec. 28, 2023

(54) SYSTEM AND METHODS FOR DYNAMIC WORKLOAD MIGRATION AND SERVICE UTILIZATION BASED ON MULTIPLE CONSTRAINTS

(71) Applicant: Accenture Global Solutions Limited, Dublin (IE)

(72) Inventors: Kaushik Amar Das, Guwahati (IN); Kapil Singi, Bangalore (IN); Kuntal Dey, Birbhum (IN); Vikrant Kaulgud, Pune (IN); Gopal Sarma Pingali, Bangalore (IN); Padmanaban Sukumaran, Bangalore (IN)

(21) Appl. No.: 18/340,564

(22) Filed: Jun. 23, 2023

(30) Foreign Application Priority Data
Jun. 24, 2022 (IN) 202241036351

(51) Int. Cl. G06F 9/48

(52) U.S. Cl. CPC G06F 9/4875

(57) ABSTRACT

The present disclosure provides systems and methods supporting dynamic migration of jobs (e.g., workloads, containers, service requests, etc.) between execution environments. The disclosed systems and methods may utilize monitoring techniques to determine when a migration should occur and/or forecasting techniques to predict optimal times when a migration should occur. Upon determining a migration should occur, a target execution environment for a job may be identified and a migration process may be initiated. In some aspects, the migration may be performed partway through processing of the job and the migration may resume processing the job after the migration is completed in a manner that enables the processing to resume at the point where processing stopped prior to the migration.

### CROSS-REFERENCE TO RELATED APPLICATIONS

The present application claims the benefit of priority from Indian Provisional Application No. 202241036351 filed Jun. 24, 2022 and entitled “SYSTEM AND METHODS FOR DYNAMIC WORKLOAD MIGRATION AND SERVICE UTILIZATION BASED ON MULTIPLE CONSTRAINTS,” the disclosure of which is incorporated by reference herein in its entirety.

### TECHNICAL FIELD

The present invention relates generally to management of computing environments and more specifically to dynamic migration of workloads between computing environments.

### BACKGROUND OF THE INVENTION

Amazon Web Services (AWS) and other cloud platform and computing environment service providers offer users workload migration capabilities, such as enabling migration of containers based on predefined time schedules or in response to events. However, such migration is static in the sense that when processing is initiated at the predetermined time or upon the occurrence of an event the processing is fixed (i.e., no migration of running processes is permitted). Thus, for example, an event may be defined and a rule configured that specifies when the event occurs a job should begin processing. Once the event occurs, the event serves as a trigger to begin processing per the corresponding rule, but that job cannot be modified or moved once processing begins.

### BRIEF SUMMARY OF THE INVENTION

Systems and methods supporting dynamic migration of workloads and workload processing between different execution environments are disclosed. The disclosed systems and methods provide functionality for monitoring execution environments to verify availability of sufficient computing resources, data residency constraints, renewable energy utilization, and other execution environment metrics (e.g., costs, carbon intensity or footprint, etc.). A job (e.g., processing of a workload) may be initiated at a particular execution environment (e.g., cloud platform, etc.) based on the monitoring, such as to initiate the job at an execution environment determined to be optimal with respect to one or more metrics.

The monitoring may continue after the job is initiated and at a subsequent time and while the job is still in progress, a determination may be made to migrate the job (e.g., processing of the workload) to a different execution environment that provides a more optimum configuration for the job with respect to the one or more metrics (e.g., optimized carbon impact, cost, etc.). When a determination to migrate to the second execution environment is made, operations may be initiated to configure the second execution environment to take over the job. After initialization, the second execution environment may be monitored for a stabilization period, which is configured to ensure the second execution environment is in a stable state prior to starting the migration of the job. After stabilization of the second execution environment is confirmed, the job may be migrated from the first execution environment to the second execution environment, at which time processing of the workload switches from the first to the second execution environment.

In some aspects, migrating from one execution environment to another may involve evaluating multiple available execution environment options, as opposed to merely switching between two execution environments. In instances where migration involves selecting one of many possible execution environments a conflict resolution process may be utilized to determine which execution environment should be selected for the migration of the job, which may take into account at least some of the metrics associated with the monitoring or other factors.

In addition to determining when to migrate, the disclosed systems and methods also provide functionality supporting forecasting techniques for performing migration between execution environments. The forecasting techniques may leverage historical migration information to predict when future migrations may occur or be advantageous. The ability to leverage such forecasting techniques may enable migrations to occur more efficiently and in the absence of any ability to observe metrics for migration analysis based on the monitoring.

### BRIEF DESCRIPTION OF THE DRAWINGS

For a more complete understanding of the present invention, reference is now made to the following descriptions taken in conjunction with the accompanying drawings, in which:

FIG. 1 shows a block diagram of an exemplary system for performing dynamic execution environment migration in accordance with the present disclosure;

FIG. 2 shows a diagram illustrating exemplary aspects of performing dynamic execution environment migration in accordance with the present disclosure;

FIG. 3 shows a diagram illustrating additional exemplary aspects of performing dynamic execution environment migration in accordance with the present disclosure;

FIG. 4 shows a diagram illustrating additional exemplary aspects of performing dynamic execution environment migration in accordance with the present disclosure; and

FIG. 5 is a flow diagram illustrating an exemplary method for performing dynamic execution environment migration in accordance with the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE INVENTION

The present disclosure provides systems and methods supporting dynamic migration of workloads or containers between execution environments. The disclosed systems and methods may utilize monitoring and/or forecasting techniques to determine when a migration should occur. Upon determining a migration should occur, a target execution environment for a workload may be identified and a migration process may be initiated. In some aspects, the migration may be performed partway through processing of the workload and the migration may resume processing the workload after the migration is completed in a manner that enables the processing to resume at the point where processing stopped prior to the migration.

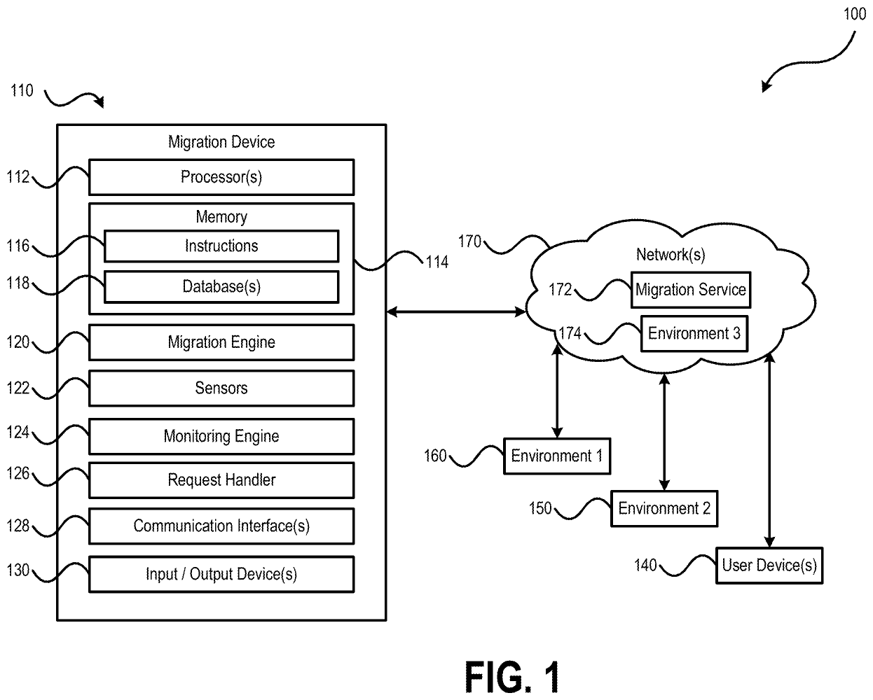

Referring to FIG. 1, a block diagram of an exemplary system for dynamic migration of workload processing between different execution environments in accordance with the present disclosure is shown as a system 100. As shown in FIG. 1, the system 100 includes a migration device 110 having one or more processors 112, a memory 114, a migration engine 120, one or more sensors 122, a monitoring engine 124, a request handler 126, one or more communications interfaces 128, and one or more input/output devices 130. These various components are configured to provide functionality to support dynamic migration of workload processing between execution environments on the fly (i.e., without restarting the job or waiting for processing to complete). These features and functionality provide enhanced abilities to migrate workload processing in an optimized manner as compared to the static techniques that currently exist and require an in-progress processing of workload to be completed or not started at the time a migration operation, as described in more detail below.

Each of the one or more processors 112 may be a central processing unit (CPU) or other computing circuitry (e.g., a microcontroller, one or more application specific integrated circuits (ASICs), and the like) and may have one or more processing cores. The memory 114 may include read only memory (ROM) devices, random access memory (RAM) devices, one or more hard disk drives (HDDs), flash memory devices, solid state drives (SSDs), network attached storage (NAS) devices, other devices configured to store data in a persistent or non-persistent state, or a combination of different memory devices. The memory 114 may store instructions 116 that, when executed by the one or more processors 112, cause the one or more processors 112 to perform the operations described in connection with the migration device 110 with reference to FIGS. 1-5.

The one or more communication interfaces 128 may be configured to communicatively couple the migration device 110 to the one or more networks 170 via wired or wireless communication links according to one or more communication protocols or standards (e.g., an Ethernet protocol, a transmission control protocol/internet protocol (TCP/IP), an institute of electrical and electronics engineers (IEEE) 802.11 protocol, and an IEEE 802.16 protocol, a 3rd Generation (3G) communication standard, a 4th Generation (4G)/long term evolution (LTE) communication standard, a 5th Generation (5G) communication standard, and the like). The I/O devices 130 may include one or more display devices, a keyboard, a stylus, one or more touchscreens, a mouse, a trackpad, a camera, one or more speakers, haptic feedback devices, or other types of devices that enable a user to receive information from or provide information to the migration device 110. It is noted that while shown in FIG. 1 as including the I/O devices 130, in some implementations the functionality of the migration device 110 may be accessed remotely by a user, such as via a communication link established between a user device 140 and the migration device 110 over the one or more networks 170. Furthermore, it should be understood that the functionality provided by the migration device 110 may also be deployed and accessed by the user in other arrangements, such as via a cloud-based implementation shown as cloud-based migration service 172, as an application accessible via a web browser of the user device 140, as an application running on the user device 140, or other types of implementations.

The migration engine 120 provides functionality supporting acquisition of migration parameters and constraints that may be used to control how migration is performed, when migration is performed, or other operations for controlling migration between different execution environments. The one or more sensors 122 may be configured to monitor different execution environment parameters, a status of in-progress workload processing of jobs, or other types of parameters or constraints that may be used to control migration operations. The monitoring engine 124 may be configured to monitor the sensor(s) 122 and communicate information associated with data collected by the sensor(s) 122 to the migration engine 120, such as information that may be used to determine whether to initiate a migration of a workload from an execution environment 150 to a different execution environment, such as execution environment 160 or execution environment 174. The request handler 126 may be configured to receive incoming jobs (e.g., workload processing requests) and may queue each received job for processing at one of the available execution environments.

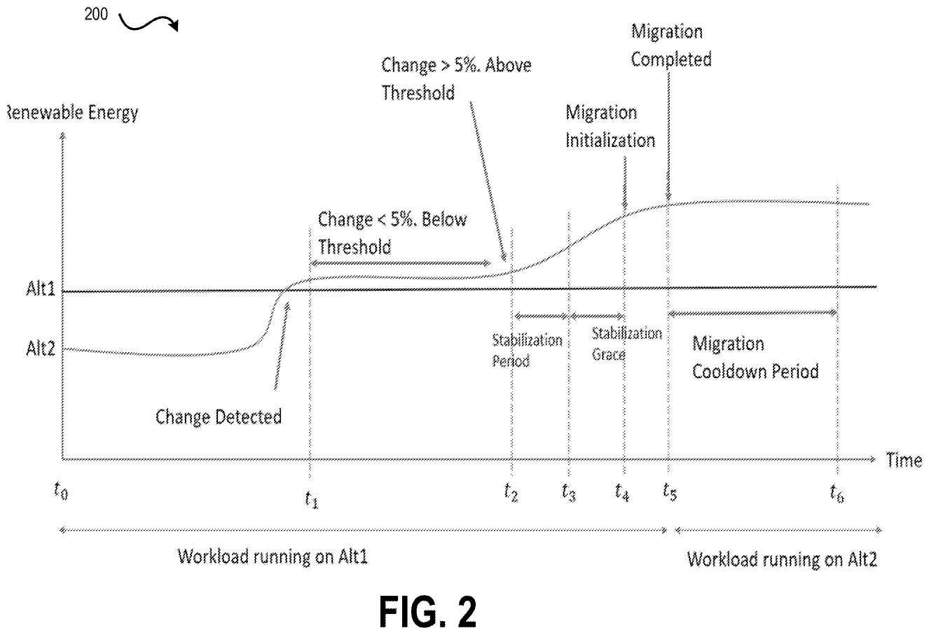

As an illustrative and non-limiting example and referring to FIG. 2, a diagram illustrating exemplary aspects of performing migration between execution environments in accordance with the present disclosure is shown as a migration process 200. As can be seen in migration process 200 of FIG. 2, processing of a workload or job may be initiated on a first execution environment (“Alt1”) starting at time (t)=0 and at approximately time (t)=1 a change may be detected (e.g., based on the monitoring described above) with reference to a second execution environment (“Alt2”). In the example of FIG. 2, the change detected at (t)=1 indicates a particular metric (e.g., one of the metrics monitored by the monitoring engine 124 and/or the sensor(s) 122) is still below a threshold change level to warrant migration from the first execution environment to the second. However, at time (t)=2, the change may be determined to exceed the threshold and as a result the second execution environment may be identified as a candidate for migration of the workload processing from the first execution environment to the second execution environment.

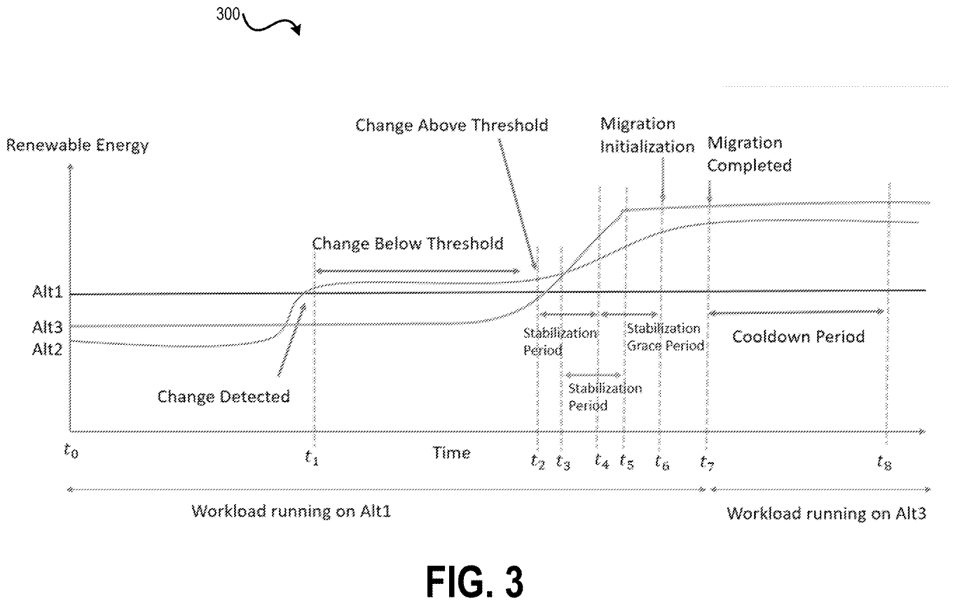

As illustrated in FIG. 2, while the second execution environment may be identified as a candidate execution environment for migrating the workload processing at time (t)=2, the migration may not be initiated until after validation of the stability state of the second execution environment. In FIG. 2, the stability state of the second execution environment is monitored from time (t)=2 until time (t)=4, where it is determined that the second execution environment is in a stable state. Monitoring the stability state of the second execution environment may include a stabilization grace period, such as is illustrated in FIG. 3 from time (t)=3 until time (t)=4. The validation of the stability state may prevent initiation of the migration operations in response to momentary spikes in the monitored metrics of the second execution environment. To illustrate, a temporary performance increase with respect to one or more monitored metrics may occur as a result of other jobs completing or being canceled, but additional jobs may be initiated shortly or concurrently thereafter, resulting in the perceived performance improvements quickly dissipating.

Once the second execution environment is determined to be in the stable state, at time (t)=4, the migration may be initiated. In an aspect, the migration may involve saving a state of the workload processing and then transferring state information to the second execution environment to enable the workload processing to be resumed in the second execution environment starting from the same point where workload processing stopped in the first execution environment. In another example, the workload processing may be restarted in the second execution environment. In such implementations, the threshold change required to initiate migration may be higher where the workload processing is restarted as compared to merely resumed from the point processing was stopped in the first execution environment in order to ensure that the benefit provided by the migration is not outweighed by the redundant processing required when the workload processing is restarted. Once the second execution environment is initialized and the migration is complete, at time (t)=5, the workload processing may be executed on the second execution environment and resources in the first execution environment may be freed up for other tasks or may become idle.

As shown in FIG. 2, a migration cooldown period may be utilized in some implementations. The migration cooldown period may correspond to a period of time during which a recently instantiated or recently migrated workload may not be migrated again. For example, the migration shown in FIG. 2 may be completed and the workload may start being processed at the second execution environment starting at time (t)=5 and the cooldown period may end at time (t)=6. Thus, between times (t)=5 and (t)=6 the workload processing may not be migrated from the second execution environment. The migration cooldown period may be used to minimize or mitigate waste when migrations between different execution environments are performed. For example, while a migration from the first execution environment to the second execution environment in the example of FIG. 2 may be performed to achieve more efficient processing of a workload (e.g., in terms of cost, energy consumption and carbon intensity or footprint, etc.), but migrating between execution environments too frequently negates the efficiency gains realized by such migrations. Thus, utilizing the migration cooldown period ensures that at least some efficiency or performance improvement is realized each time a migration is performed.

Referring back to FIG. 1, in some implementations the migration engine 120 may be configured to leverage a multiple-criteria decision analysis (MCDA) technique, such as a technique for order of preference by similarity to ideal solution (TOPSIS), to identify or select which execution environment is to be chosen for a given migration. In some implementations, a preferred execution environment may be identified or selected based on a ranking of the available execution environments. For example, Table 1 below shows a non-limiting example illustrating how comparison of different computing or execution environments described with respect to FIG. 2 may be ranked for migration suitability based on a particular metric (e.g., one of the metrics monitored by the monitoring engine 124 and/or the sensor(s) 122).

TABLE 1

| | Monitored Metric (%) | | |
|---|---|---|---|
| Time | Alt1 | Alt2 | Ranking |
| (t) = 0 | 50 | 35 | [Alt1, Alt2] |
| (t) = 1 | 50 | 53 | [Alt2, Alt1] |
| (t) = 2 | 50 | 55 | [Alt2, Alt1] |
| (t) = 3 | 50 | 60 | [Alt2, Alt1] |
| (t) = 4 | 50 | 70 | [Alt2, Alt1] |
| (t) = 5 | 50 | 75 | [Alt2, Alt1] |
| (t) = 6 | 50 | 76 | [Alt2, Alt1] |

For example, in some implementations there may be many potential execution environments suitable for processing a particular workload, each having particular metrics that the migration engine 120 of FIG. 1 may use to determine the optimal environment for migration. The MCDA or TOPSIS technique used by the migration engine 120 to select one of the available alternatives for the migration target may be configured to evaluate two or more parameters to determine the target execution environment for a given migration, where the MCDA/TOPSIS technique enables identification of an optimal execution environment despite different parameters being used and different parameter values for each execution environment being considered. For example, an ideal execution environment may be defined using a multidimensional model, such as one axis for each parameter, and the parameter values of the individual execution environments may be input into the model. Once input into the model, a distance between each candidate execution environment and the ideal execution environment may be determined based on observed parameter values and the candidate execution environment providing the closest match (e.g., shortest distance to positive ideal execution environment, most positive distance, etc.) to the ideal environment may be selected for use in migration.

In addition to the above-described functionality, which is based on monitoring the various execution environments, in some implementations the migration device 110 may also provide functionality for forecasting migrations. The forecasting operations may utilize machine learning techniques to predict or forecast when migrations would be beneficial. For example, historical migration data may indicate that migration between a first and second execution environment frequently occurs on a particular day, at a particular time, during a particular season, or some other criteria. Such observations may then be used to predict when a particular migration should occur and/or to schedule the migration. In some instances, such historical migration data may be stored in and/or retrieved from the one or more database 118, which may include a historical database maintaining values for metrics of interest observed over time.

In an aspect, clustering techniques may be leveraged to identify such migration operations. For example, historical data for a time period (e.g., the last month, last week, last X days, etc.) may be analyzed using a clustering algorithm to identify optimal migrations for workloads and/or service requests. As a result, future migrations may be predicted based on optimal performance of available execution environments according to one or more clusters, each identifying an optimal execution environment for processing a particular type of workload or service request. To illustrate, migration data for a previous 6 days for training of artificial intelligence workloads may be analyzed and 2 clusters may be generated. Each of the 2 clusters may predict an optimal execution environment for training of artificial intelligence workloads on the 7^{th} day, which may indicate training of artificial intelligence workloads should be migrated to a first execution environment at a first time on the 7^{th} day and them migrated to a second execution environment at a second time on the 7^{th} day to obtain optimal processing performance.

The ability to use the above-described forecasting techniques to predict when migrations should occur, what target environments should be chosen for the migrations, or other migration parameters may enable the migration device 110 to operate without the sensors 122 and/or without monitoring the various environments, or at least not monitoring them as frequently, thereby providing a more independent system for managing migration between different execution environments. While capable of operating without monitoring where forecasting techniques are used, it is noted that in some implementations monitoring may be used in addition to the forecasting techniques, which may improve the results achieved for forecasted migrations due to enhanced datasets due to the monitoring.

Referring to FIG. 3, a diagram illustrating exemplary aspects of performing migration between execution environments in accordance with the present disclosure is shown as a migration process 300. As can be seen in migration process 300 of FIG. 3, processing of a workload or job may be initiated on a first execution environment (“Alt1”) starting at time (t)=0 and at approximately time (t)=1 a change may be detected (e.g., based on the monitoring described above) with reference to a second execution environment (“Alt2”) and a third execution environment (“Alt3”). In the example of FIG. 3, the change detected at (t)=1 indicates a particular metric (e.g., one of the metrics monitored by the monitoring engine 124 and/or the sensor(s) 122) is still below a threshold change level to warrant migration from the first execution environment to the second. However, at time (t)=2, the change may be determined to exceed the threshold with respect to the second execution environment but not the third execution environment. As a result, the second execution environment may be identified as a candidate for migration of the workload processing from the first execution environment to the second execution environment.

However, the change as to the third execution environment may exceed the threshold during the stabilization period, thereby establishing the third execution environment as another candidate execution environment. In such a situation, a conflict is presented whereby two alternative execution environments are viable candidates for user in a migration from the first execution environment. To resolve this conflict the modelling engine may reevaluate the second and third execution environments after the stabilization phase is completed to identify whether the second or third execution environment should be chosen for the migration from the first execution environment. As can be seen in FIG. 3, the third execution environment may be selected as providing a higher optimization based on analysis of the migration engine 120 and therefore, the migration may be instantiated on the third execution environment. In an aspect, the above-described MCDA/TOPSIS techniques may be used to resolve the conflict and select the second or third execution environment. For example, resolving a conflict between the execution environments may include ranking the execution environments for migration suitability based on a particular metric, as illustrated in Table 2, below.

TABLE 2

| | Monitored Metric (%) | | | |
|---|---|---|---|---|
| Time | Alt1 | Alt2 | Alt3 | Ranking |
| (t) = 0 | 50 | 35 | | [Alt1, Alt2] |
| (t) = 1 | 50 | 53 | | [Alt2, Alt1] |
| (t) = 2 | 50 | 55 | 47 | [Alt2, Alt1, Alt3] |
| (t) = 3 | 50 | 60 | 55 | [Alt2, Alt1, Alt3] |
| (t) = 4 | 50 | 70 | 75 | [Alt3, Alt2, Alt1] |
| (t) = 5 | 50 | 75 | 80 | [Alt3, Alt2, Alt1] |
| (t) = 6 | 50 | 76 | 81 | [Alt3, Alt2, Alt1] |
| (t) = 7 | 50 | 76 | 82 | [Alt3, Alt2, Alt1] |
| (t) = 8 | 50 | 76 | 82 | [Alt3, Alt2, Alt1] |

As shown in Table 2, at time t=0, two execution environment (e.g., Alt1 and Alt2) may be monitored and Ala may be ranked higher than Alt 2 due to Alt 1 having a higher monitored metric (e.g., a higher percentage of green energy utilization, lower carbon intensity, etc.). As such, at time t=0 Alt1 may be the preferred execution environment. At time t=1 Alt2 may exhibit an improved monitored metric, resulting in Alt2 being the higher ranked execution environment and Alt1 becoming the lower ranked execution environment. In an aspect, the difference in the performance metric between Alt1 and Alt2 at time t=1 may be below a migration performance metric and so migration from Alt1 to Alt2 may not be initiated (e.g., because the performance improvement may be insufficient to justify migration). For example, the migration performance metric may specify a threshold performance increase (e.g., 5%, 10%, 15%, 20%, etc.). As an additional or alternative example, the migration performance metric may specify that migration should not occur if a current workload or service request has reached a threshold completion level (e.g., 80%, 85%, 90%, 95%, etc.) such that completion of processing of the workload or service request may be more efficiently completed (e.g., from a processing and computational resources perspective) on a current execution environment rather than being migrated. It is noted that in some aspects, multiple migration performance metrics may be considered, such as those described above or other metrics when determining whether to migrate to a new execution environment.

At time t=2, a third execution environment (e.g., Alt3) may begin being monitored and may be the third ranked execution environment. Additionally, at time 1=2 Alt2 may satisfy the migration performance metric(s), which may initiate a stabilization period to determine whether the performance metric(s) of Alt2 is stable (i.e., not a temporary occurrence). At time t=3, Alt3 may overcome Alt1 (i.e., the current execution environment) to become the second ranked execution environment and may satisfy the migration performance metric, which may initiate a stabilization period for Alt3. At time t=4 Alt3 may become the highest ranked execution environment and Alt2 may complete the stabilization period. As described herein, when the stabilization period ends, and assuming the performance is stable, a stabilization grace period may begin, which is a period of time to allow conflict resolution to occur. In the example shown in Table 2 above, the conflict being resolved during the stabilization grace period may be the conflict between Alt2 having completed the stabilization period but Alt3 being the highest ranked execution environment, but in the stabilization period. At time t=5, Alt3 completes the stabilization period and remains the highest ranked execution environment. At time t=6, the stabilization grace period may end and Alt 3 may remain the highest ranked execution environment. As a result, migration of a workload or service request may be migrated to Alt3.

At time t=7, migration to Alt 3 may be completed and a cooldown period may be initiated. As explained above, the cooldown period may be a period of time in which no migrations are performed to avoid migrating too often, which may be inefficient. At time t=8, the cooldown period may end and the system may begin determining whether the migrate the workload or service request from Alt3. However, since Alt3 remains the highest ranked execution environment at time t=8 no migration operations may be initiated. As shown in the example above, embodiments of the present disclosure may enable conflict resolution processing to be performed to account for conflicts that may arise during migration determinations and may enable the most efficient processing of workloads despite the occurrence of a conflict.

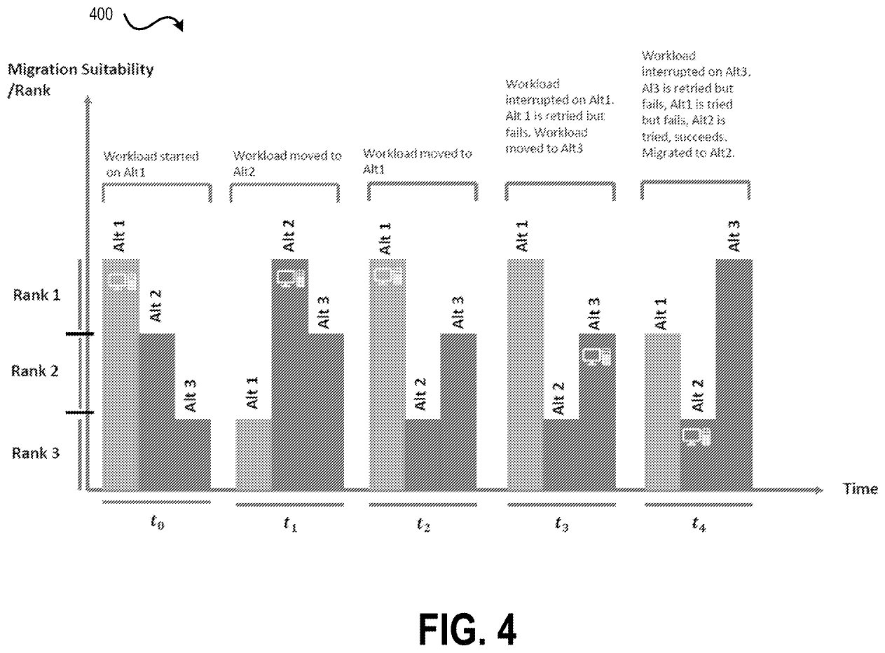

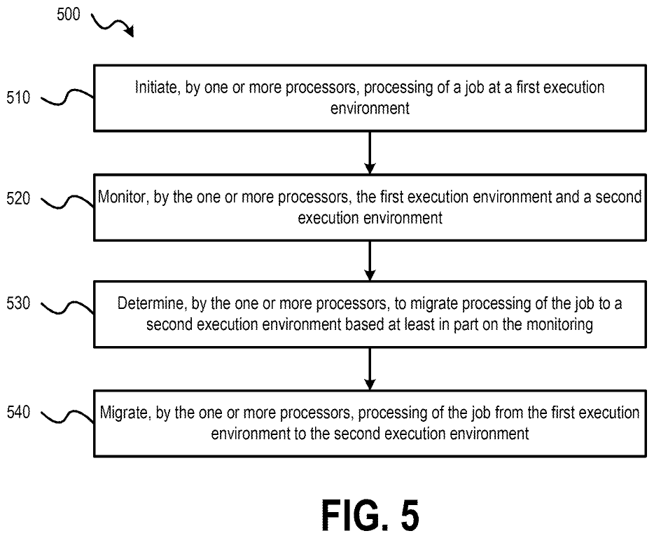

Referring to FIG. 4, a diagram illustrating additional exemplary aspects of performing dynamic execution environment migration in accordance with aspects of the present disclosure is shown as a migration process 500. As can be seen in the example migration process 500 of FIG. 5, processing of a workload or job may be initiated on a first execution environment (“Alt1”) starting at time (t)=0. At time (t)=0, the first execution environment, as well as a second execution environment (“Alt2”) and a third execution environment (“Alt3”) may be monitored for a particular metric (e.g., one of the metrics monitored by the monitoring engine 124 and/or the sensor(s) 122). At time (t)=1, the second execution environment may rank higher for migration suitability, and so the workload may be migrated to the second execution environment according to the principles discussed above with respect to FIGS. 2 and 3. After the appropriate cooldown period has completed, at time (t)=2, the first execution environment may be ranked higher than the third execution environment, which may in turn be ranked higher than the second execution environment, and so the workload may be migrated back to the first execution environment using the techniques described herein. If the workload is interrupted at the first execution environment and/or otherwise unable to be processed (e.g., processing fails, cannot be performed at a desired performance level, etc.), such as at time (t)=3, then process failure recovery operations may be initiated. In an aspect, the process failure recovery operations may include reinitializing or retrying the workload at a current execution environment (e.g., “Alt1” in the example shown in FIG. 5). In an aspect, reinitializing or retrying the workload at the current execution environment may be performed according to a processing recovery parameter. For example, the processing recovery parameter may specify a threshold number of times (e.g., one time, two times, three times, etc.) that processing should be retried at the current execution environment before determining to migrate the workload or service request to a new execution environment in accordance with the techniques described herein. As another example, the processing recovery parameter may specify a period of time (e.g., 5 minutes, 10 minutes, 20 minutes, etc.) during which attempts to retry processing of the workload or service request in the current execution environment should be attempted before determining to migrate the workload or service request to a new execution environment in accordance with the techniques described herein.

If attempts to retry or reinitialize processing of the workload on the first execution environment according to the processing recovery parameter(s) fail, the workload (or service request) may be migrated to the next highest ranked execution environment in accordance with the techniques described herein, such as the third execution environment at time (t)=3 in this example. If the workload is interrupted or fails after or during migration to the third execution environment, such as at time (t)=4, attempts to resume or reinitialize the processing may be performed according to one or more processing recovery parameters as described above. However, if such attempts are unsuccessful, a determination to migrate the workload (or service request) to the first or second execution environments may be performed. As described herein, such a determination may be based on a ranking of the execution environments for migration suitability using one or more migration metrics.

It is noted that in some of the examples above, the migration metrics considered when determining to migrate processing of workloads and/or service requests relate to singular metrics, such as a percentage of renewable energy. However, in some aspects, determinations to migrate processing of workloads may account for multiple different migration metrics and types of migration metrics. For example, an execution environment may be ranked highly for a particular metric (e.g., a metric representing an environment's utilization of renewable energy), but otherwise is not suitable for executing a workload, the system may determine not to migrate the workload to that environment. For example, suppose that an amount of renewable energy is determined to be a preferred particular metric for a workload, and an execution environment ranks highly for the amount of renewable energy it consumes, but ranks poorly for other monitored metrics such as cost, reliability, efficiency, or processing time. Such an execution environment may not be desirable for migrating workloads. In an aspect, execution environments may have their failures monitored, tracked, and or stored, such as in a database (e.g., the one or more databases 118 of FIG. 1) of performance history. In some implementations, a penalty metric may be applied to ranking determinations to account for an execution environment's past failures or poor performance. In some implementations, multiple metrics may all be monitored such that workloads are only migrated to execution environments which can adequately perform the workloads, and resources are not spent migrating workloads to execution environments ranked highly for one metric (e.g., Renewable energy use) but ranked unacceptably low for other metrics (e.g., cost and/or reliability). Such metrics may have weights assigned to them to facilitate this determination. An example of how these factors may interact with each other is shown in Table 3 below.

TABLE 3

| | Cost($)/hr | | | Eviction Rate (%) | | | Renewable Energy (%) | | | |
|---|---|---|---|---|---|---|---|---|---|---|
| | (Weight: 0.5) | | | (Weight: 0.4) | | | (Weight: 0.1) | | | |
| Time | Alt1 | Alt2 | Alt3 | Alt1 | Alt2 | Alt3 | Alt1 | Alt2 | Alt3 | Ranking |
| (t) = 0 | 4.65 | 5.67 | 4.60 | 5 | 6 | 8 | 50 | 35 | 30 | Alt1, Alt2, |
| | | | | | | | | | | Alt3 |
| (t) = 1 | 7.65 | 4.67 | 4.60 | 5 | 6 | 7 | 50 | 35 | 30 | Alt2, Alt3, |
| | | | | | | | | | | Alt1 |
| (t) = 2 | 5.65 | 5.67 | 4.60 | 5 | 6 | 7 | 60 | 55 | 47 | Alt1, Alt3, |
| | | | | | | | | | | Alt2 |
| (t) = 3 | 5.65 | 5.67 | 4.60 | 5 | 6 | 7 | 60 | 55 | 47 | Alt1, Alt3, |
| | | | | | | | | | | Alt2 |
| (t) = 4 | 6.00 | 5.67 | 4.60 | 5 | 6 | 4 | 60 | 55 | 47 | Alt3, Alt1, |
| | | | | | | | | | | Alt2 |

In the example shown in Table 3 above, migration suitability for three execution environments (e.g., Alt1, Alt2, Alt3) are shown over 5 time periods from t=0 to t=4. Initially, at t=0, Alt1 may be the highest ranked execution environment based on the three monitored metrics, which include cost, eviction rate (%), and renewable energy utilization (%). However, at time t=1 the cost of Alt1 may increase significantly and Alt2 may decrease approximately 20% (e.g., from $5.67 to $4.67). Based on the weightings of the various metrics, Alt 2 may become the highest ranked execution environment and processing may be migrated to Alt 2 using the concepts described herein (e.g., stabilization period, grace period, cooldown, etc.). At time t=2 Alt 1 may again become the highest ranked execution environment based on the monitored metrics and associated rankings and processing may be migrated back to Alt1. However, the processing of the workload may fail at Alt1 and may be migrated to Alt2 following completion of the process recovery operations at Alt 1.

At time t=3 the workload or service request may be evicted by Alt1. As explained herein, when the eviction occurs process recovery operations may be performed. In the example shown Table 3, the process recovery operations may be unsuccessful and the workload or service request is migrated to Alt3. At time t=3 the workload or service request may be evicted by Alt3. As explained herein, when the eviction occurs process recovery operations may be performed. In the example shown Table 3, the process recovery operations may be unsuccessful and the workload or service request is migrated to Alt2.

As shown above, embodiments of the present disclosure provide robust migration capabilities that may account for multiple monitored metrics to identify an optimal execution environment and may also provide for failure recovery and other aspects of the migration and processing of workloads to ensure workloads and service requests are processed in an optimal manner. In a similar manner to the dynamic migration processes discussed above relative to FIGS. 2-4, the MCDA/TOPSIS techniques described above with reference to Table 3 may be used for workloads and service requests to determine the best execution environment in which to process the workload or service request as metrics associated with available monitored execution environments change. In such implementations, parameters that are to be monitored and their respective weightages may be configured by a system administrator and may be periodically updated. In an aspect, execution environments may also be selected based on business constraints, such as geographic constraints. When a customer request arrives, it may be serviced in the execution environment with the highest “service suitability” indicated by the MCDA/TOPSIS ranks. In case of failure, the request may be retried in the next best execution environment until it is successfully completed. Alternatively, the request may be processed on an execution environment that has historically performed well for similar requests. Other mechanisms for servicing requests may be performed in a similar manner to dynamic migration processes, such as the user being able to update the system parameters as and when required.

Referring to FIG. 5, a flow diagram illustrating an exemplary method for migrating between different execution environments in accordance with the present disclosure is shown as a method 500. In an aspect, the method 500 may be performed by a computing device, such as the migration device 110 or the user device 130 of FIG. 1, or via a cloud-based system, such as cloud-based migration service 172 of FIG. 1. In an aspects, steps of the method 500 may be stored as instructions (e.g., the instructions 116 of FIG. 1) that, when executed by one or more processors (e.g., the one or more processors 112 of FIG. 1), cause the one or more processors to perform operations corresponding to the steps of the method 500.

At step 510, the method 500 includes initiating, by one or more processors, processing of a job at a first execution environment. As explained above, the job may include a workload, such as training of an artificial intelligence model, or may include a service request. At step 520, the method 500 includes monitoring, by the one or more processors, the first execution environment and a second execution environment. As explained above, the monitoring may be configured to evaluate each execution environment of a plurality of execution environments with respect to one or more metrics (e.g., utilization (%) of green or renewable energy, performance metrics such as failure or eviction rates, job processing completion percentage, etc.). At step 530, the method 500 includes determining, by the one or more processors, to migrate processing of the job to the second execution environment based at least in part on the monitoring. As described elsewhere herein, it should be appreciated that step 530 may additionally include determining whether to migrate the job to other execution environments, rather than just determining between the first and second execution environments. Additionally, it is noted that determining to migrate the processing of the job may also include other operations described herein, such as verifying the stability of an execution environment, conflict resolution, and the like. At step 540, the method 500 includes migrating, by the one or more processors, processing of the job from the first execution environment to the second execution environment. It is noted that the method 500 may include additional operations consistent with the operations described above with reference to FIGS. 1-4.

It is noted that the exemplary use cases described above, as well as the processes, methods, and techniques for controlling migration of processing between multiple execution environments have been primarily described with respect to migration between 2 or 3 execution environments. However, that these use cases have been described for purposes of illustrating the migration techniques disclosed herein, rather than by way of limitation, and it should be understood that the migration techniques described throughout this disclosure may be applied to any number of execution environments (e.g., 2 or more). Indeed, such techniques may become more useful, applicable, and necessary as the number of potentially viable alternative execution environments increases. For example, applying techniques like those described herein may enable more effective workload migrations by providing new capabilities to optimize where workloads and service requests are processed based on multiple optimization factors (e.g., utilization (%) of green or renewable energy utilized by an execution environment, failure/reliability and other performance metrics, workload processing completion status, and other factors, such as processing failure recovery operations). Workload effectiveness As a result, effectiveness of processing of workloads and/or service requests may increase as an optimal execution environment for a given workload may be quickly identified from several potential execution environments, ranked, and migrated to.

The benefits of applying migration techniques such as those described in this disclosure are numerous. For example, migrating workloads to execution environments ranking highly for renewable energy use may reduce the carbon footprint of the workload. In addition to the environmental benefits, reducing a workload's carbon footprint may enable greater consumer satisfaction or peace of mind, which may provide business advantages. Another exemplary benefit may come from performing migrations into execution environments with greater processing capability and/or more computing resources available may improve processing and/or workload performance. This may increase processing speed, saving time and costs associated with longer runtimes. Yet another exemplary benefit of the techniques described herein may include providing more robust failure recovery capabilities. For example, as was discussed above related to FIG. 4, when workloads are evicted from execution environments or otherwise fail to perform, a migration to a new execution environment may include, for example, performing recovery operations. Such recovery operations may be able to compensate for the failure in one execution environment. In some example applications of the techniques of this disclosure, failures in a given execution environment may even be able to be predicted and planned for, again increasing productivity and efficiency for the workloads.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A method for dynamic migration of job processing between different execution environments, the method comprising:
initiating, by one or more processors, processing of a job at a first execution environment, wherein the job comprises a workload or a service request;
monitoring, by the one or more processors, the first execution environment and a second execution environment;
determining, by the one or more processors, to migrate processing of the job to a second execution environment based at least in part on the monitoring; and
migrating, by the one or more processors, processing of the job from the first execution environment to the second execution environment.

2. The method of claim 1, further comprising initializing the second execution environment subsequent to determining to migrate processing of the job from the first execution environment to the second execution environment.

3. The method of claim 2, further comprising monitoring the second execution environment subsequent to the initializing to detect a stabilization state of the second execution environment, wherein the migrating is initiated in response to detection that the second execution environment is in a stabilized state.

4. The method of claim 1, further comprising:
monitoring a third execution environment; and
performing conflict resolution operations between the second execution environment and the third execution environment, wherein the conflict resolution is configured to determine whether the migrating is to be initiated with respect to the second execution environment or the third execution environment, wherein the processing of the job is migrated to the second execution environment or the third execution environment based on an outcome of the conflict resolution operations.

5. The method of claim 1, wherein the monitoring is configured to measure utilization of green or renewable energy utilized by the first execution environment and the second execution environment, and wherein the determination to migrate the processing of the job to the second execution environment is based on the utilization of green or renewable energy utilized by the first execution environment and the second execution environment.

6. The method of claim 5, wherein the monitoring is configured to monitor one or more additional metrics associated with processing of jobs, the one or more additional metrics comprising performance metrics, a completion status of the processing of the job, processing failure recovery metrics, or a combination thereof, and wherein the determination to migrate the processing of the job to the second execution environment is based on the utilization of green or renewable energy utilized by the first execution environment and the second execution environment and the one or more additional metrics.

7. The method of claim 1, further comprising initiating processing failure recovery operations in response to a failure with respect to processing of the job at the second execution environment, wherein the failure recovery processing is configured to initiate migration to a different execution environment in response to failure of a processing recovery parameter.

8. A system for dynamic migration of job processing between different execution environments, the system comprising:
a memory; and
one or more processors communicatively coupled to the memory and configured to:
initiate processing of a job at a first execution environment;
monitor a plurality of execution environments that includes the first execution environment and at least a second execution environment;
determine to migrate processing of the job to a second execution environment based at least in part on the monitoring; and
migrate processing of the job from the first execution environment to the second execution environment.

9. The system of claim 8, wherein the one or more processors are configured to:
detect a stabilization state of the second execution environment, wherein the migrating is initiated in response to detection that the second execution environment is in a stabilized state; and
initialize the second execution environment subsequent to determining to migrate processing of the job from the first execution environment to the second execution environment and detecting the second execution environment is in a stabilized sate.

10. The system of claim 8, wherein the one or more processors are configured to:
track historical metrics associated with a plurality of execution environments;
apply a machine learning algorithm to the historical metrics to predict optimal migration of jobs between at least some execution environments of the plurality of execution environments; and
initiate migration of one or more the jobs to particular execution environments of the at least some execution environments based on predictions by the machine learning algorithm.

11. The system of claim 10, wherein the machine learning algorithm comprises a clustering algorithm.

12. The system of claim 11, further comprising performing conflict resolution between the second execution environment and the third execution environment, and wherein the processing of the second job is migrated to the second execution environment or the third execution environment based on an outcome of the conflict resolution.

13. A non-transitory computer-readable storage medium storing instructions that, when executed by one or more processors, cause the one or more processors to perform operations for dynamic migration of job processing between different execution environments, the operations comprising:
initiating processing of a job at a first execution environment;
monitoring at least the first execution environment and a second execution environment;
determining to migrate processing of the job to the second execution environment based at least in part on the monitoring; and
migrating processing of the job from the first execution environment to the second execution environment.

14. The non-transitory computer-readable storage medium of claim 13, further comprising initializing the second execution environment subsequent to determining to migrate processing of the job from the first execution environment to the second execution environment.

15. The non-transitory computer-readable storage medium of claim 14, further comprising monitoring the second execution environment subsequent to the initializing to detect a stabilization state of the second execution environment, wherein the migrating is initiated in response to detection that the second execution environment is in a stabilized state.

16. The non-transitory computer-readable storage medium of claim 13, further comprising monitoring one or more additional execution environments that are different from the first execution environment and the second execution environment.

17. The non-transitory computer-readable storage medium of claim 16, further comprising performing conflict resolution between the second execution environment and the third execution environment, wherein the conflict resolution is configured to determine whether migration of a second job is to be initiated with respect to the second execution environment or the third execution environment.

18. The non-transitory computer-readable storage medium of claim 17, wherein the processing of the job is migrated to the second execution environment based on an outcome of the conflict resolution.

19. The non-transitory computer-readable storage medium of claim 13, the operations further comprising:
monitoring a third execution environment; and
performing conflict resolution operations between the second execution environment and the third execution environment, wherein the conflict resolution operations are configured to determine whether to migrate a second job to the second execution environment or the third execution environment, wherein the processing of the second job is migrated to the second execution environment or the third execution environment based on an outcome of the conflict resolution operations

20. The non-transitory computer-readable storage medium of claim 13, the operations further comprising:
tracking historical metrics associated with a plurality of execution environments;
predicting optimal times to migrate jobs between a plurality of execution environments based on historical metrics associated with the plurality of execution environments using a machine learning algorithm; and
initiating migration of one or more the jobs to particular execution environments of the plurality of execution environments based on the predicted optimal times determined using the machine learning algorithm.
